(19) United States
(12) Patent Application Publication
(10) Pub. No.: US 2026/0197554 A1
(43) Pub. Date: Jul. 9, 2026

(54) IMAGING SENSING DEVICE, ELECTRONIC DEVICE HAVING THE SAME, AND METHOD OF OPERATING ELECTRONIC DEVICE

(71) Applicant: SAMSUNG ELECTRONICS CO., LTD., Suwon-si (KR)

(72) Inventors: DAEHEE BAE, Suwon-si (KR); HEESUNG SHIM, Suwon-si (KR); JOONHO LEE, Suwon-si (KR); HYUKBIN KWON, Suwon-si (KR); MINWOONG SEO, Suwon-si (KR); JAEKYU LEE, Suwon-si (KR)

(73) Assignee: SAMSUNG ELECTRONICS CO., LTD., Suwon-si (KR)

(21) Appl. No.: 19/293,619

(22) Filed: Aug. 7, 2025

(30) Foreign Application Priority Data
Jan. 9, 2025 (KR) 10-2025-0003398

(51) Int. Cl. H04N 23/667; H04N 25/531; H04N 25/532

(52) U.S. Cl. CPC H04N 23/667; H04N 25/531; H04N 25/532

(57) ABSTRACT

A method of operating an electronic device which includes an application processor and an image sensing device is provided. The method includes: generating, by the image sensing device, first image data in a first shutter mode; providing, by the application processor, the image sensing device with a first mode change signal indicating a second shutter mode different from the first shutter mode, based on photographing environment information associated with the first image data, to the image sensing device; and generating, by the image sensing device, second image data in the second shutter mode, based on the first mode change signal.

### CROSS-REFERENCE TO RELATED APPLICATION

This application claims priority under 35 U.S.C. § 119 to Korean Patent Application No. 10-2025-0003398, filed on Jan. 9, 2025, in the Korean Intellectual Property Office, the disclosure of which is incorporated by reference herein in its entirety.

### BACKGROUND

The present disclosure relates to an electronic device, and more particularly, to an image sensing device switching a shutter mode depending on a photographing environment, an electronic device including the image sensing device, and an operating method of the electronic device.

An image sensor converts a light received through a photodiode into an electrical signal. A complementary metal oxide semiconductor (CMOS) image sensor may provide a convenient driving method, low power consumption, and the integration of a signal processing circuit on a single chip.

As the use of the CMOS image sensor sharply increases, there is an increasing need for an image sensor which is quickly switched into a mode appropriate for a photographing environment.

### SUMMARY

One or more embodiments provide an image sensing device switching a shutter mode depending on a photographing environment, an electronic device including the image sensing device, and an operating method of the electronic device.

According to an aspect of an embodiment, a method of operating an electronic device which includes an application processor and an image sensing device includes generating, by the image sensing device, first image data in a first shutter mode, providing, by the application processor, the image sensing device with a first mode change signal indicating a second shutter mode different from the first shutter mode, based on photographing environment information associated with the first image data, to the image sensing device, and generating, by the image sensing device, second image data in the second shutter mode, based on the first mode change signal.

According to another aspect of an embodiment, a method of operating a system-on-chip which includes a sensor controller and an image sensor includes generating, by the image sensor, first image data in a first shutter mode, changing, by the sensor controller, a setting of the image sensor based on photographing environment information associated with the first image data to control the image sensor to operate in a second shutter mode different from the first shutter mode, and generating, by the image sensor, second image data in the second shutter mode.

According to another aspect of an embodiment, an electronic device includes an image sensing device configured to generate first image data in a first shutter mode and a second shutter mode; and an application processor configured to provide the image sensing device with a first mode change signal indicating a shutter mode different from a current shutter mode, based on photographing environment information associated with the first image data.

### BRIEF DESCRIPTION OF DRAWINGS

The above and other aspects will be more apparent from the following description of embodiments, taken in conjunction with the accompanying drawings.

FIG. 1 is a block diagram of an electronic device according to some embodiments.

FIG. 2 is a block diagram of an electronic device according to some embodiments.

FIG. 3 is a diagram illustrating an image sensing device, according to some embodiments.

FIG. 4 is a diagram schematically describing a rolling shutter mode among shutter modes according to some embodiments.

FIG. 5 is a diagram schematically describing a global shutter mode among shutter modes according to some embodiments.

FIG. 6 is a circuit diagram of a pixel circuit, according to some embodiments.

FIG. 7 is a timing diagram describing change of a shutter mode, according to some embodiments.

FIG. 8 is a diagram describing setting data according to some embodiments.

FIG. 9 is a diagram describing an operating method of an electronic device of FIG. 1, according to some embodiments.

FIG. 10 is a flowchart describing an operating method of an application processor over time, according to some embodiments.

FIG. 11 is a diagram describing an operating method of an electronic device, according to some embodiments.

FIG. 12 is a block diagram of a system-on-chip according to some embodiments.

FIG. 13 is a diagram describing an operating method of a system-on-chip, according to some embodiments.

FIG. 14 is a block diagram of an electronic device including a multi-camera module according to some embodiments.

FIG. 15 is a block diagram illustrating a camera module according to some embodiments.

### DETAILED DESCRIPTION

Below, embodiments will be described with reference to the drawings. Embodiments described herein are provided as examples, and thus, the present disclosure is not limited thereto, and may be realized in various other forms. Each example embodiment provided in the following description is not excluded from being associated with one or more features of another example or another example embodiment also provided herein or not provided herein but consistent with the present disclosure.

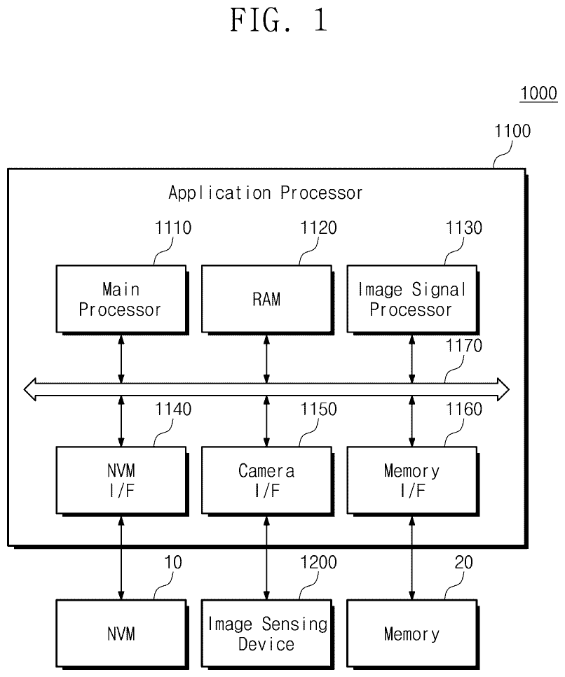

FIG. 1 is a block diagram of an electronic device 1000 according to some embodiments. Referring to FIG. 1, the electronic device 1000 may include an application processor 1100 and an image sensing device 1200.

The electronic device 1000 may be implemented with a laptop computer, a mobile phone, a smartphone, a tablet PC, a personal digital assistant (PDA), an enterprise digital assistant (EDA), a digital still camera, a digital video camera, a portable multimedia player (PMP), a mobile Internet device (MID), a wearable computer, an Internet of things (IoT) device, or an Internet of everything (IoE) device.

The application processor 1100 may include a main processor 1110, a random access memory (RAM) 1120, an image signal processor 1130, a nonvolatile memory interface 1140, a camera interface 1150, and a memory interface 1160.

The main processor 1110 may control all operations of the application processor 1100. For example, the main processor 1110 may be implemented with a central processing unit (CPU) or a microprocessor. The main processor 1110 may be implemented with one computing component including two or more independent processors (or cores) depending on an embodiment, that is, a multi-core processor. The main processor 1110 may execute programs stored in the RAM 1120 (or a read only memory (ROM)) or may process data stored therein.

The RAM 1120 may temporarily store programs, data, or instructions. For example, the RAM 1120 may be implemented with a dynamic RAM (DRAM) or a static RAM (SRAM). The RAM 1120 may temporarily store an image which is input/output through the interfaces 1140, 1150, and 1160 or which the image signal processor 1130 or the main processor 1110 generates.

In some embodiments, the application processor 1100 may further include a read only memory (ROM). The ROM may store programs and/or data which are consistently used. The ROM may be implemented with an erasable programmable ROM (EPROM) or an electrically erasable programmable ROM (EEPROM).

The image signal processor 1130 may generate a converted image by performing image processing on image data received from the image sensing device 1200 and may store the converted image in a memory 20. The image signal processor 1130 may scale the converted image and may provide the scaled image to a display device.

The nonvolatile memory interface 1140 may interface data which are input from a nonvolatile memory device 10 or are output to the nonvolatile memory device 10. The nonvolatile memory device 10 may be implemented, for example, with a memory card (e.g., MultiMediaCard (MMC), Embedded MMC (eMMC), Secure Digital (SD), or micro SD).

The camera interface 1150 may interface image data which are input from the image sensing device 1200 placed outside the application processor 1100. The image sensing device 1200 may generate image data of an image photographed by using a plurality of light detection elements. Image data which are received through the camera interface 1150 may be provided to the image signal processor 1130 or may be stored in the memory 20 through the memory interface 1160.

For example, the camera interface 1150 may be implemented with one of the following interfaces: a serial interface, a mobile display digital interface (MDDI), an inter integrated circuit (I2C) interface, a serial peripheral interface (SPI), a micro controller unit (MCU) interface, a mobile industry processor interface (MIPI), an embedded display port (eDP) interface, a D-subminiature (D-sub), an optical interface, or a high definition multimedia interface (HDMI). In addition, the camera interface 1150 may be implemented in various serial or parallel interface manners.

However, embodiments are not limited thereto. For example, unlike the example illustrated in FIG. 1, the application processor 1100 may further include additional components or may not include some of the above components. For example, the image signal processor 1130 may be included in the image sensing device 1200.

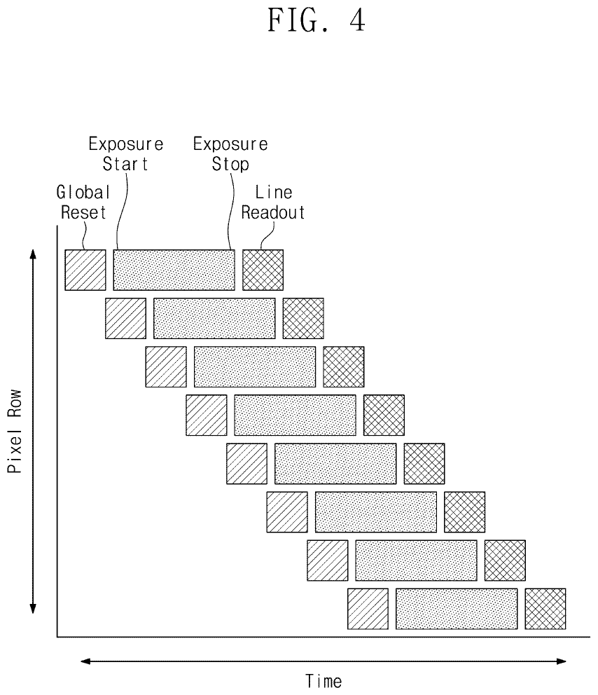

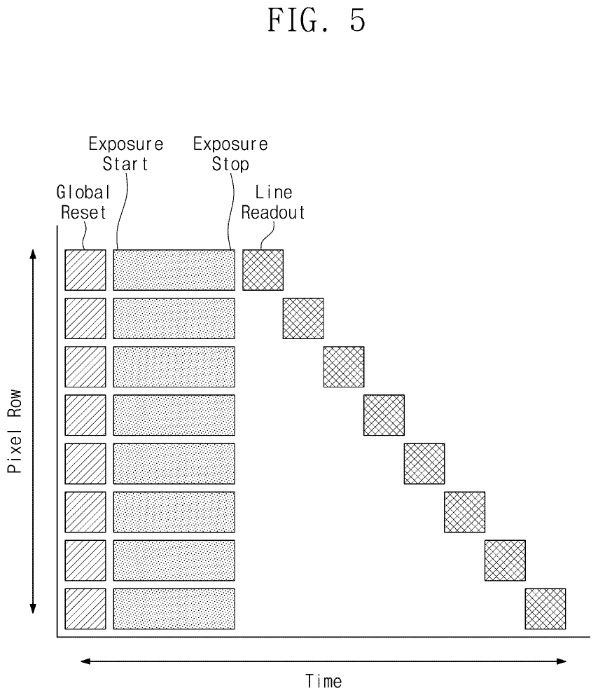

The electronic device 1000 may change a shutter mode depending on a photographing environment. The electronic device 1000 may generate data of an image photographed in the changed shutter mode or may display the photographed image. The image sensing device 1200 may generate data of an image photographed in one shutter mode among a plurality of shutter modes. For example, the plurality of shutter modes may include a rolling shutter mode and a global shutter mode. This will be described in detail with reference to FIGS. 4 and 5.

In detail, for example, the image sensing device 1200 may generate first image data in a first shutter mode. The image sensing device 1200 may provide the first image data to the application processor 1100 through the camera interface 1150. The application processor 1100 may provide the image sensing device 1200 with a mode change signal for changing the first shutter mode to a second shutter mode different from the first shutter mode, based on photographing environment information about the first image data. The photographing environment information may include data which are associated with factors capable of causing a noise in the image data generated by the image sensing device 1200 or are associated with a movement of a photographing object.

For example, the photographing environment information may include at least one of illuminance information, gain amplification information, and movement information.

The illuminance information may indicate an illuminance value corresponding to the illuminance of the photographed frame. For example, the application processor 1100 may calculate the illuminance value from the first image data. For example, the illuminance value may be an average value of the illuminance of the first image data or may be the maximum value or the minimum value of the illuminance of the first image data.

The gain amplification information may indicate a multiple value for amplifying a signal output from a pixel circuit of the image sensing device 1200. The image sensing device 1200 may obtain bright image data even in a dark place by amplifying the signal output from the pixel circuit. For example, the image sensing device 1200 may adjust a gain in units of x4 or x1.

The movement information may include movement vector data indicating a moving direction and a speed of an object in the frame and movement strength data corresponding to the magnitude of a pixel value change. For example, the movement vector data may be expressed by a two-dimensional vector. For example, the application processor 1100 may calculate a movement amount based on the magnitude of the movement vector data and the movement strength data. The movement amount may be expressed by a scalar value.

In some embodiments, the application processor 1100 may obtain the photographing environment information from the image data received from the image sensing device 1200 or from metadata of the image data.

In some embodiments, the application processor 1100 may obtain the photographing environment information from metadata which are stored in an internal or external memory of the application processor 1100 and are associated with the corresponding image data. For example, the application processor 1100 may store and retain the metadata to be provided to the image sensing device 1200 in the process in which the image sensing device 1200 generates the corresponding image data.

The application processor 1100 may determine whether to change a shutter mode, based on the photographing environment information. For example, different threshold values may be associated with different shutter modes. For example, the application processor 1100 may compare values included in the photographing environment information with the threshold values and based on the comparison, may determine to change a current shutter mode (e.g., the first shutter mode) to another shutter mode (e.g., the second shutter mode). In this case, the application processor 1100 may provide the image sensing device 1200 with the mode change signal indicating the shutter mode to change to (e.g., the second shutter mode).

The image sensing device 1200 may operate in the second shutter mode based on the mode change signal. For example, the image sensing device 1200 may generate second image data in the second shutter mode in response to the mode change signal.

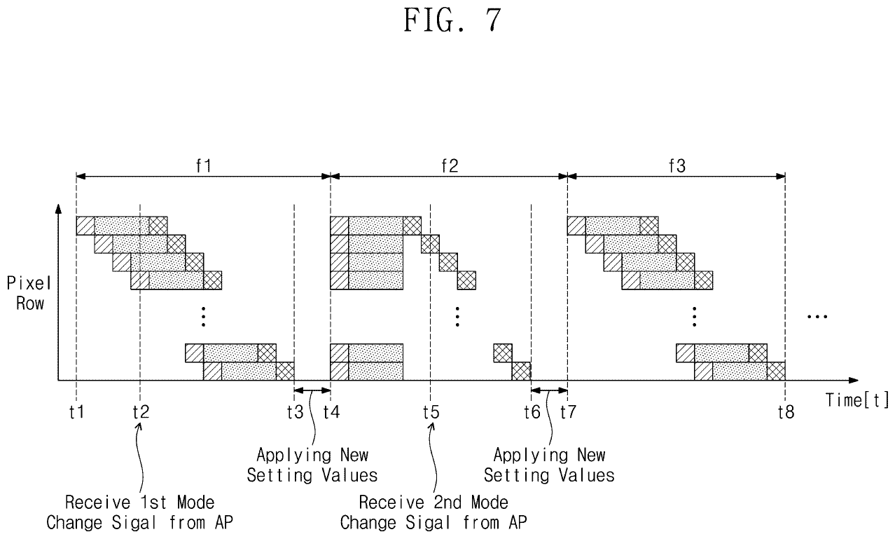

In some embodiments, the image sensing device 1200 may operate in the second shutter mode during a frame period which starts after the mode change signal is received. This will be described in detail with reference to FIG. 7.

In some embodiments, the image sensing device 1200 may be formed on one semiconductor substrate. The image sensing device 1200 may be implemented with a system-on-chip. In this case, the application processor 1100 may be formed on a semiconductor substrate which is independent of the semiconductor substrate of the image sensing device 1200.

According to the electronic device 1000 according to some embodiments, the application processor 1100 may determine whether to change the shutter mode based on photographing environment information in real time (or periodically), and thus, when there is a need to change the shutter mode, the application processor 1100 may quickly change the shutter mode.

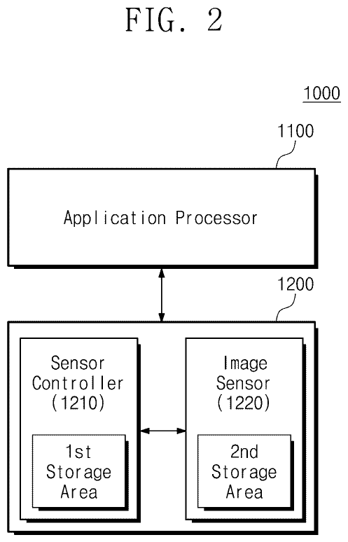

FIG. 2 is a block diagram of the electronic device 1000 according to some embodiments. Referring to FIG. 2, the image sensing device 1200 may include a sensor controller 1210 and an image sensor 1220. The application processor 1100 and the image sensing device 1200 of FIG. 2 respectively correspond to the application processor 1100 and the image sensing device 1200 of FIG. 1.

The sensor controller 1210 may control all operations of the image sensor 1220. The sensor controller 1210 may change settings of the image sensor 1220. For example, the sensor controller 1210 may change the shutter mode of the image sensor 1220. In detail, the sensor controller 1210 may provide setting values corresponding to different shutter modes to the image sensor 1220. The sensor controller 1210 may change the shutter mode of the image sensor 1220 by storing the setting values of the image sensor 1220 (e.g., in registers of the image sensor 1220).

The sensor controller 1210 may provide the application processor 1100 with the image data received from the image sensor 1220. The sensor controller 1210 may receive the mode change signals from the application processor 1100.

The sensor controller 1210 may obtain setting data corresponding to a target shutter mode (e.g., the second shutter mode) indicated by the mode change signal, based on the mode change signal. For example, the sensor controller 1210 may include a first storage area. For example, the image sensor 1220 may include a second storage area. The first storage area or the second storage area may store the setting data corresponding to the target shutter mode.

That is, the sensor controller 1210 may read the setting data corresponding to the target shutter mode from the first storage area or the second storage area, based on the mode change signal.

In some embodiments, each of the first storage area and the second storage area may include at least one of registers, an SRAM, and a ROM. However, embodiments are not limited thereto. For example, the first storage area and the second storage area may respectively include memories capable of storing different kinds of data.

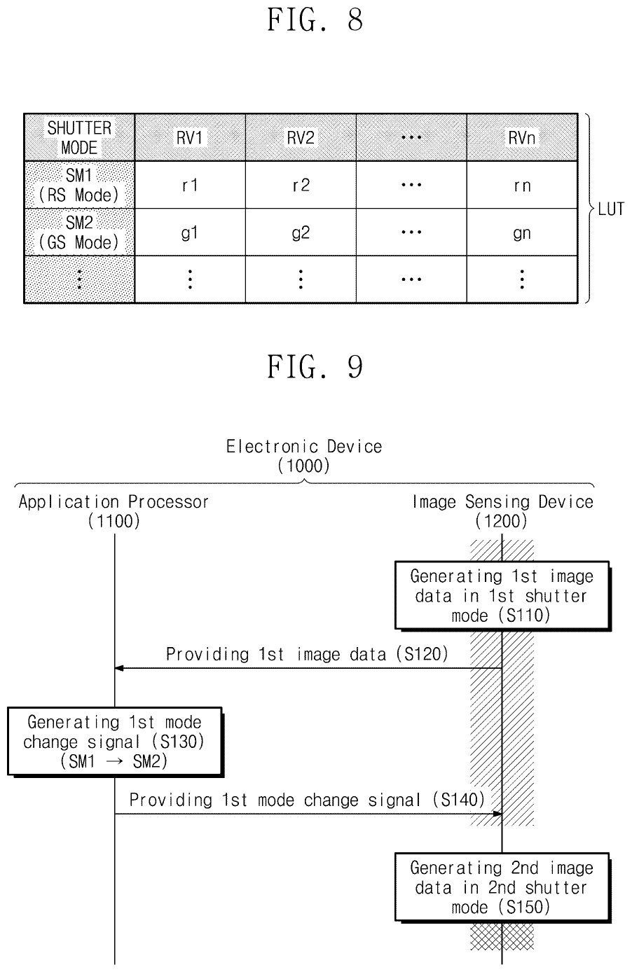

In some embodiments, the setting data may be stored in the form of a lookup table (LUT) including a plurality of shutter modes and a plurality of setting values. This will be described in detail with reference to FIG. 8.

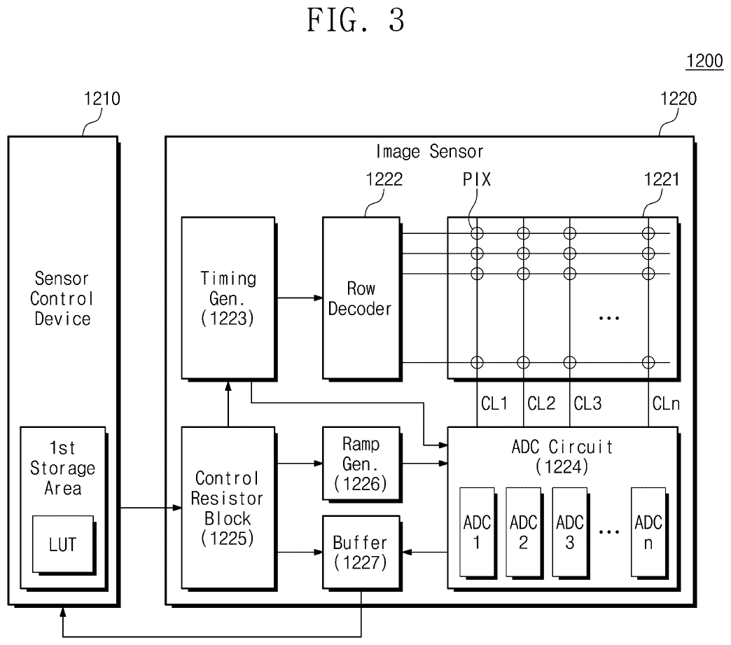

The image sensor 1220 may convert a light, which is incident after being reflected by or emitted from a photographing object, into a digital signal. The image sensor 1220 will be described in detail with reference to FIG. 3.

FIG. 3 is a diagram illustrating the image sensing device 1200 of FIG. 2 in detail, according to some embodiments. The sensor controller 1210 and the image sensor 1220 will be described in detail with reference to FIG. 3. The sensor controller 1210 and the image sensor 1220 of FIG. 3 respectively correspond to the sensor controller 1210 and the image sensor 1220 of FIG. 2.

The image sensor 1220 may include a pixel array 1221, a row driver (e.g., row driver circuit) 1222, a timing generator (e.g., timing generation circuit) 1223, an analog-to-digital converter (ADC) circuit 1224, a control register block (e.g., control register circuit) 1225, a ramp signal generator (e.g., ramp signal generation circuit) 1226, and a buffer (e.g., buffer circuit) 1227.

The pixel array 1221 may include a plurality of pixel circuits PIX arranged in the form of a matrix including a plurality of rows and a plurality of columns. Each of the plurality of pixel circuits PIX may be referred to as a unit pixel in that the plurality of pixel circuits PIX constitute one pixel array 1221.

Under control of the timing generator 1223, the row driver 1222 may transmit a plurality of control signals for controlling an operation of each of the plurality of pixel circuits PIX to the pixel array 1221.

Under control of the control register block 1225, the timing generator 1223 may control operations of the row driver 1222, the ADC circuit 1224, and the ramp signal generator 1226.

The ADC circuit 1224 may include a plurality of ADCs ADC1 to ADCn. The plurality of ADCs ADC1 to ADCn, and may perform correlated double sampling on pixel signals respectively output from a plurality of column lines CL1 to CLn implemented in the pixel array 1221. Each of the ADCs ADC1 to ADCn may compare the corresponding correlated double sampled pixel signal with a ramp signal output from the ramp signal generator 1226 (e.g., with a voltage level) and may output a comparison signal depending on a result of the comparison. Each of the ADCs ADC1 to ADCn may convert the comparison signal into a digital signal and may output the digital signal to the buffer 1227.

In some embodiments, the ADC circuit 1224 may be referred to as a readout circuit.

Under control of the sensor controller 1210, the control register block 1225 may control the timing generator 1223, the ramp signal generator 1226, and the buffer 1227.

In some embodiments, the sensor controller 1210 may store a plurality of setting values of the setting data corresponding to the target shutter mode in the control register block 1225. That is, the sensor controller 1210 may change the values stored in a plurality of registers of the control register block 1225 to the setting values of the setting data. Accordingly, the sensor controller 1210 may change the shutter mode of the image sensor 1220.

In some embodiments, a setting value stored in a register may indicate a start point and an end point of each of pulse signals which are used for the image sensor 1220.

The buffer 1227 may transmit a plurality of digital pixel signals respectively corresponding to the plurality of digital signals output from the ADC circuit 1224 to the sensor controller 1210 as the image data.

FIG. 4 is a diagram schematically describing a rolling shutter mode according to embodiments.

In the rolling shutter mode, an image sensor may sequentially perform a reset operation and a readout operation on target pixel circuits in units of row. As shown in the rolling shutter mode, different rows of the image sensor are reset, exposed and read out at slightly different times. The rolling shutter mode may result in skew between rows.

FIG. 5 is a diagram schematically describing a global shutter mode according to embodiments.

In the global shutter manner, signals converted by photodiodes respectively included in all pixel circuits (hereinafter referred to as “target pixel circuits”) of a target area are simultaneously transferred to floating diffusion nodes, and digital signals corresponding to each of rows sequentially selected may be output.

In detail, in the global shutter manner, after the image sensor simultaneously resets the target pixel circuits, the image sensor may simultaneously transfer charges corresponding to the light received by the photodiodes to the floating diffusion nodes during the same time period. Therefore, the target pixel circuits start and stop their exposure simultaneously, which eliminates the time skew between rows. Afterwards, as the rows are sequentially selected, pixel signals of the target pixel circuits may be sequentially read out.

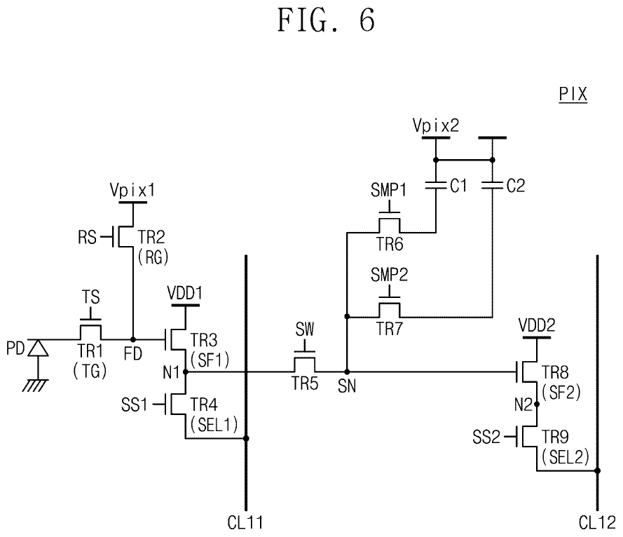

FIG. 6 is a circuit diagram of a pixel circuit PIX of FIG. 3, according to some embodiments. A detailed circuit diagram of the pixel circuit PIX is illustrated in FIG. 6.

The pixel circuit PIX according to one or more embodiments may be referred to as operating in a hybrid global shutter mode in that the pixel circuit PIX is capable of operating in the rolling shutter mode or the global shutter mode.

The pixel circuit PIX may include a photodiode PD, first to ninth transistors TR1 to TR9, a first capacitor C1, and a second capacitor C2.

The photodiode PD may receive a light and may generate charges corresponding to the intensity or amount of the received light.

The first transistor TR1 may be connected between the photodiode PD and a floating diffusion node FD, and may include a gate receiving a transfer signal TS. The first transistor TR1 may be referred to as a transfer transistor TG.

The second transistor TR2 may be connected between a first power terminal and the floating diffusion node FD and may include a gate receiving a reset signal RS. In this case, the first power terminal may receive a first power supply voltage Vpix1. The second transistor TR2 may be referred to as a reset transistor RG.

The third transistor TR3 may be connected between a second power terminal and a first node N1 and may include a gate connected to the floating diffusion node FD. In this case, the second power terminal may receive a first power supply voltage Vpix1. The third transistor TR3 may perform a source follower function of outputting a voltage of the floating diffusion node FD. The third transistor TR3 may be referred to as a “first source follower transistor” SF1.

The fourth transistor TR4 may be connected between the first node N1 and a column line CL11 and may include a gate receiving a first selection signal SS1. When the readout operation is performed, the fourth transistor TR4 may transfer a voltage of the first node N1 to the column line CL11. Also, the fourth transistor TR4 may perform an on/off function on the column line CL11. For example, when 0 V is applied to the gate of the fourth transistor TR4, the fourth transistor TR4 may turn off the column line CL11. In this regard, TR4 may disconnect the first node N1 from the column line CL11. The fourth transistor TR4 may be referred to as a first selection transistor SEL1.

The fifth transistor TR5 may be connected between the first node N1 and a storage node SN and may include a gate receiving a first switch signal SW.

The sixth transistor TR6 may be connected between the storage node SN and a first end of the first capacitor C1 and may include a gate receiving a first sampling signal SMP1.

The seventh transistor TR7 may be connected between the storage node SN and a first end of the second capacitor C2 and may include a gate receiving a second sampling signal SMP2.

The eighth transistor TR8 may be connected between the second power terminal and a second node N2 and may include a gate connected to the storage node SN. In this case, the second power terminal may receive the second power supply voltage Vpix2. The eighth transistor TR8 may perform a source follower function of outputting a voltage of the storage node SN. The eighth transistor TR8 may be referred to as a “second source follower transistor” SF2.

The ninth transistor TR9 may be connected between the second node N2 and a column line CL12 and may include a gate receiving a second selection signal SS2. When the readout operation is performed, the ninth transistor TR9 may transfer a voltage of the second node N2 to the column line CL12. Also, the ninth transistor TR9 may perform an on/off function on the column line CL12. For example, when 0 V is applied to the gate of the ninth transistor TR9, the ninth transistor TR9 may turn off the column line CL12. In this regard, TR9 may disconnect the first node N2 from the column line CL12. The ninth transistor TR9 may be referred to as a second selection transistor SEL2.

A second end of the first capacitor C1 may be connected to the second power terminal. A second end of the second capacitor C2 may be connected to the second power terminal. In this regard, the first capacitor C1 and the second capacitor C2 may be connected in parallel between the storage node SN and the second power terminal in a state where the sixth transistor TR6 and the seventh transistor TR7 are turned on.

The first capacitor C1 may store charges corresponding to a reset level signal from among the charges of the floating diffusion node FD. The second capacitor C2 may store charges corresponding to a sensing level signal from among the charges of the floating diffusion node FD. In an embodiment, each of the reset level signal and the sensing level signal may be used in the correlated double sampling manner.

When the image sensor operates in the rolling shutter mode, the fifth transistor TR5 may be turned off by the switch signal SW. In contrast, when the image sensor operates in the global shutter mode, the fifth transistor TR5 may be turned on by the switch signal SW.

In some embodiments, the image sensor may operate in one shutter mode among the rolling shutter mode and the global shutter mode by using the setting values stored in the register.

For example, the image sensor may control at least one of a resetting timing, a light receiving timing, and a readout timing by using the setting values stored in the register.

In some embodiments, the column lines CL11 and CL12 may be may be connected to one of the plurality of column lines CL1 to CLn of FIG. 3.

FIG. 7 is a timing diagram describing change of a shutter mode, according to some embodiments. A timing at which an image sensing device changes a shutter mode will be described with reference to FIG. 7.

The image sensing device may change the shutter mode after a currently progressing frame period ends and before a next frame period starts. The frame period indicates a time period from a start time point at which image data of one frame are output to a start time point at which image data of a next frame are output. In this case, the frame refers to a set of all pixels constituting one image.

In detail, the image sensing device may operate in the target shutter mode during a frame period which starts after the mode change signal is received (i.e., the first full frame period that follows reception of the mode change signal).

For example, during a first frame period f1, the image sensing device may operate in the first shutter mode (e.g., the rolling shutter mode). The first frame period f1 indicates a time period from a first time point t1 at which a global reset of a first row for obtaining image data of a first frame starts, to a fourth time point t4 at which a global reset of a first row for obtaining image data of a second frame starts.

The image sensing device may receive a first mode change signal from an application processor at a second time point t2 between the first time point t1 and a third time point t3 at which the readout operation on the last row in the frame is terminated. The first mode change signal may indicate the second shutter mode (e.g., the global shutter mode). The image sensing device may obtain first setting data corresponding to the second shutter mode, based on the first mode change signal. The image sensing device may continue to operate in the first shutter mode from the second time point t2 to the third time point t3.

The image sensing device may apply the setting values of the first setting data corresponding to the second shutter mode between a time period from t3 to t4, in which there is no output of image data. That is, the image sensing device may store the corresponding setting values in registers of the image sensor. Afterwards, under control of a sensor controller, the image sensor may operate in the second shutter mode during a second frame period f2 from the fourth time point t4, based on the setting values stored in the registers.

During the second frame period f2, the image sensing device may operate in the second shutter mode (e.g., the global shutter mode). The second frame period f2 indicates a time period from the fourth time point t4 at which a global reset of a first row for obtaining image data of a second frame starts to a seventh time point t7 at which a global reset of a first row for obtaining image data of a third frame starts.

The image sensing device may receive a second mode change signal from the application processor at a fifth time point t5 between the fourth time point t4 and a sixth time point t6 at which the readout operation on the last row in the second frame is terminated. The second mode change signal may indicate the first shutter mode (e.g., the rolling shutter mode). The image sensing device may obtain second setting data corresponding to the first shutter mode, based on the second mode change signal. The image sensing device may continue to operate in the second shutter mode from the fifth time point t5 to the sixth time point t6.

The image sensing device may apply the setting values of the second setting data corresponding to the first shutter mode between a time period from t6 to t7, in which there is no output of image data. That is, the image sensing device may store the corresponding setting values in registers of the image sensor. Afterwards, under control of the sensor controller, the image sensor may operate in the first shutter mode from the seventh time point t7, based on the setting values stored in the registers.

For convenience of description, an example in which the second setting data are applied in the second frame period f2 immediately after the first setting data are applied in the first frame period f1 is illustrated, but embodiments are not limited thereto. For example, the image sensing device may receive the second mode change signal in a third frame period f3, not the second frame period f2. In this case, the image sensing device may operate in the first shutter mode during a fourth frame period immediately after the third frame period f3.

FIG. 8 is a diagram describing setting data according to some embodiments. Setting data which are stored in an image sensing device in the form of an LUT will be described with reference to FIG. 8.

The setting data may include a plurality of shutter modes and a plurality of setting values.

For example, the setting data may include a first shutter mode SM1 and a second shutter mode SM2. The first shutter mode SM1 may be the rolling shutter (RS) mode, and the second shutter mode SM2 may be the global shutter (GS) mode.

The setting data may include a plurality of setting values RV1 and RVn corresponding to each shutter mode. In this case, “n” is an arbitrary natural number.

The setting data may include a plurality of setting values r1 to rn as the plurality of setting values RV1 and RVn corresponding to the first shutter mode SM1.

The setting data may include a plurality of setting values g1 to gn as the plurality of setting values RV1 and RVn corresponding to the second shutter mode SM2.

FIG. 9 is a diagram describing an operating method of the electronic device 1000 of FIG. 1, according to some embodiments. Referring to FIG. 9, the electronic device 1000 may include the application processor 1100 and the image sensing device 1200.

In operation S110, the image sensing device 1200 may generate first image data in the first shutter mode SM1.

In operation S120, the image sensing device 1200 may provide the first image data to the application processor 1100.

In operation S130, the application processor 1100 may generate the first mode change signal indicating the second shutter mode SM2 different from the first shutter mode SM1.

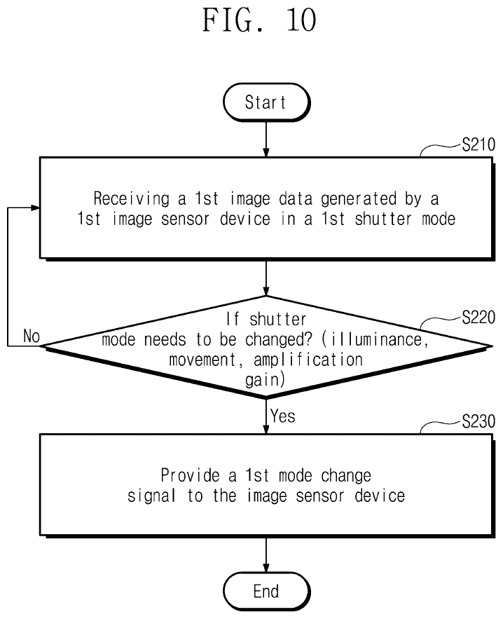

In detail, the application processor 1100 may determine whether to change the shutter mode, based on photographing environment information associated with the first image data. This will be described in detail with reference to FIG. 10.

In operation S140, the application processor 1100 may provide the first mode change signal to the image sensing device 1200. For example, the application processor 1100 may provide the first mode change signal to the image sensing device 1200 when it is determined to change the shutter mode.

In operation S150, the image sensing device 1200 may generate second image data in the second shutter mode SM2.

In some embodiments, the image sensing device 1200 may obtain first setting data corresponding to the second shutter mode SM2, based on the first mode change signal. For example, the image sensing device 1200 may store and retain the first setting data in the sensor controller or the image sensor. The image sensing device 1200 may change the shutter mode of the image sensor by storing the first setting data in the register of the image sensor.

In some embodiments, the image sensing device 1200 may operate in the second shutter mode SM2 during a frame period which starts after the first mode change signal is received.

FIG. 10 is a flowchart describing an operating method of the application processor 1100 of FIG. 1 over time, according to some embodiments. An operating method of an application processor will be described over time with reference to FIG. 10.

In operation S210, the application processor may receive first image data generated in the first shutter mode from an image sensing device.

In operation S220, the application processor may determine whether to change the shutter mode, based on photographing environment information associated with the first image data.

In some embodiments, the application processor may obtain at least portion of the photographing environment information based on the first image data. Alternatively, the application processor may obtain at least portion of the photographing environment information based on metadata of the first image data transmitted from the image sensing device together with the first image data. Alternatively, the application processor may obtain at least portion of the photographing environment information based on the metadata of the first image data stored in an internal or external memory of the application processor.

In some embodiments, the application processor may determine that the first shutter mode is the global shutter mode and an illuminance value of photographing environment information is less than a first threshold value. The application processor may generate the first mode change signal indicating the rolling shutter mode as the second shutter mode. In this case, the first threshold value may be a preset value.

In some embodiments, the application processor may determine that the first shutter mode is the rolling shutter mode and the illuminance value of the photographing environment information is greater than a second threshold value. In this case, the second threshold value may be greater than the first threshold value and may be a preset value. The application processor may generate the first mode change signal indicating the global shutter mode as the second shutter mode.

According to the above description, an electronic device may operate in the global shutter mode when it is bright and may operate in the rolling shutter mode when it is dark.

In some embodiments, the application processor may determine that the first shutter mode is the rolling shutter mode and a speed value of the photographing environment information speed greater than a third threshold value. The application processor may generate the first mode change signal indicating the global shutter mode as the second shutter mode. The third threshold value may be a preset value.

In some embodiments, the application processor may determine that the first shutter mode is the global shutter mode and the speed value of the photographing environment information is less than a fourth threshold value. In this case, the fourth threshold value may be less than the third threshold value and may be a preset value. The application processor may generate the first mode change signal indicating the rolling shutter mode as the second shutter mode.

According to the above description, the electronic device may operate in the global shutter mode when there is a lot of movement and may operate in the rolling shutter mode when there is little movement.

In some embodiments, the application processor may determine that the first shutter mode is the rolling shutter mode and a multiple value of gain amplification information included in the photographing environment information is less than a fifth threshold value. The application processor may generate the first mode change signal indicating the global shutter mode as the second shutter mode. The fifth threshold value may be a preset value.

In some embodiments, the application processor may determine that the first shutter mode is the global shutter mode and the multiple value of the gain amplification information included in the photographing environment information is greater than a sixth threshold value. In this case, the sixth threshold value may be greater than the fifth threshold value and may be a preset value. The application processor may generate the first mode change signal indicating the rolling shutter mode as the second shutter mode.

According to the above description, the electronic device may operate in the rolling shutter mode in an environment where the probability that a noise increases due to a great multiple value of the gain amplification information is high and may operate in the global shutter mode in an environment where the probability that a noise increases due to a small multiple value of the gain amplification information is not high.

When it is determined that there is a need to change the shutter mode, the application processor may perform operation S230; when it is determined that there is no need to change the shutter mode, the application processor may again perform operation S210.

In operation S230, the application processor may provide the first mode change signal to the image sensing device.

The image sensing device may change a setting based on the first mode change signal so as to operate in the second shutter mode switched from the first shutter mode.

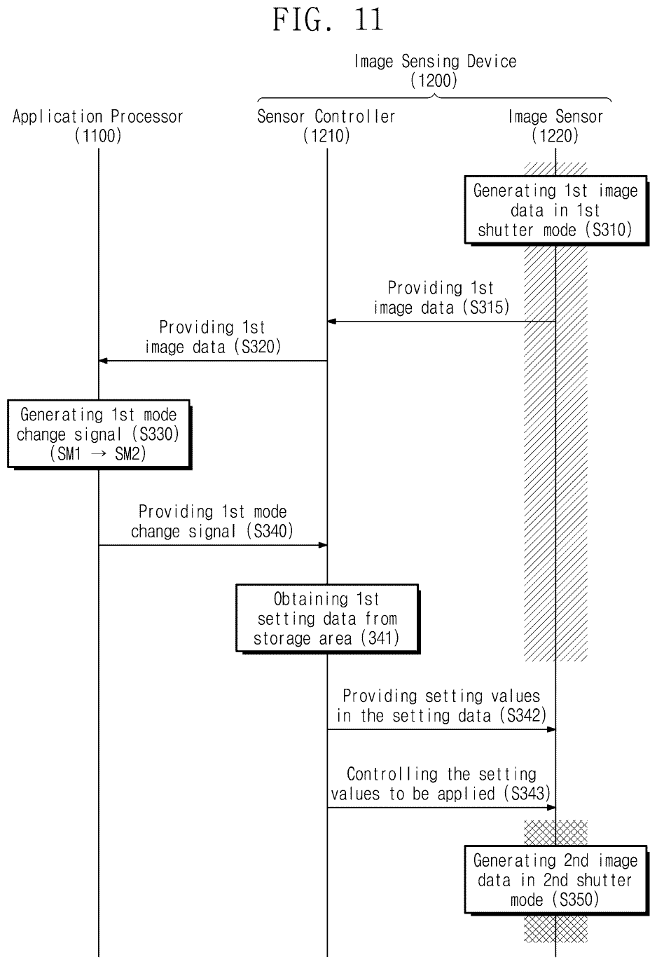

FIG. 11 is a diagram describing an operating method of the electronic device 1000 of FIG. 2, according to some embodiments. How the application processor 1100, the sensor controller 1210, and the image sensor 1220 operate will be described with reference to FIG. 11.

For convenience, the description which is given with reference to FIGS. 9 and 10 will be omitted to avoid redundancy.

In operation S310, the image sensor 1220 may generate first image data in the first shutter mode SM1.

In operation S315, the image sensor 1220 may provide the first image data to the sensor controller 1210.

In operation S320, the sensor controller 1210 may provide the first image data to the application processor 1100. In operation S330, the application processor 1100 may generate the first mode change signal indicating the second shutter mode SM2 different from the first shutter mode SM1. In operation S340, the application processor 1100 may provide the first mode change signal to the sensor controller 1210.

In operation S341, the sensor controller 1210 may obtain first setting data corresponding to the second shutter mode SM2, based on the first mode change signal. In detail, the sensor controller 1210 may obtain the first setting data from one of the first storage area of the sensor controller 1210 and the second storage area of the image sensor 1220.

In operation S342, between a time point at which the output of image data in a current frame period ends and a time point at which a next frame period starts, the sensor controller 1210 may provide setting values of the first setting data to the image sensor 1220.

In operation S343, between a time point at which the setting values are provided to the image sensor 1220 and a time point at which a next frame period starts, the setting values may be applied to the image sensor 1220 under control of the sensor controller 1210. In detail, in this case, the sensor controller 1210 may store the setting values in the registers of the image sensor 1220.

In operation S350, during the next frame period, the image sensor 1220 may generate second image data in the second shutter mode

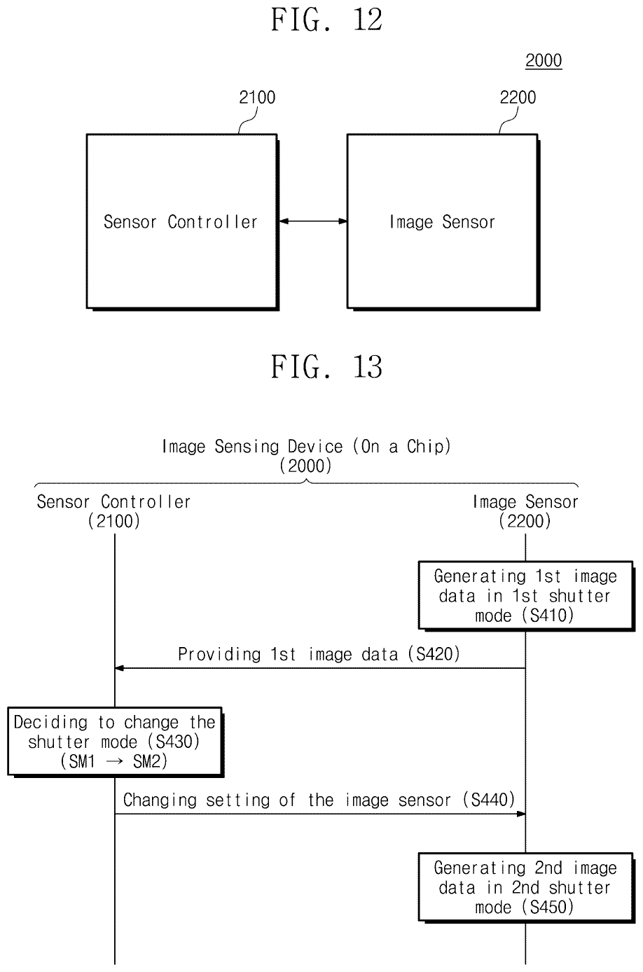

FIG. 12 is a block diagram of a system-on-chip 2000 according to some embodiments. Referring to FIG. 12, a system-on-chip including a sensor controller 2100 and an image sensor 2200 is illustrated. For convenience, the description which is given with reference to FIG. 3 will be omitted to avoid redundancy.

Components of the system-on-chip may be formed on one semiconductor substrate.

The sensor controller 2100 may control all operations of the image sensor 2200. The sensor controller 2100 may change the shutter mode of the image sensor 2200.

In detail, the sensor controller 2100 may receive first image data generated in the first shutter mode from the image sensor 2200.

The sensor controller 2100 may change a setting of the image sensor 2200 based on photographing environment information associated with the first image data such that the image sensor 2200 operates in the second shutter mode different from the first shutter mode.

In some embodiments, the sensor controller 2100 may include a micro control unit (MCU). At least part of the sensor controller 2100 may be implemented by firmware.

In some embodiments, the sensor controller 2100 may compare the photographing environment information with at least one threshold values and may determine whether to change the shutter mode of the image sensor 2200. A detailed comparing method is similar to that described with reference to FIG. 10.

In some embodiments, the sensor controller 2100 may obtain at least portion of the photographing environment information from the first image data. Alternatively, the sensor controller 2100 may obtain at least portion of the photographing environment information from the metadata of the first image data provided from the image sensor 2200 together with the first image data. Alternatively, the sensor controller 2100 may be provided with the metadata of the first image data stored in an external application processor (e.g., the application processor of FIG. 1) and may obtain at least portion of the photographing environment information from the provided metadata.

In some embodiments, the sensor controller 2100 may determine to change the shutter mode based on the photographing environment information associated with the first image data. In this regard, the sensor controller 2100 may determine (or select) the second shutter mode as the target shutter mode. The sensor controller 2100 may obtain first setting data corresponding to the second shutter mode. The first setting data may be stored in a first storage area of the sensor controller 2100 (e.g., the first storage area of FIG. 2) or a second storage area of the image sensor 2200 (e.g., the second storage area of FIG. 2).

In some embodiments, the sensor controller 2100 may provide at least one setting value of the first setting data to the image sensor 2200. The image sensor 2200 may store the at least one setting value in at least one register. Accordingly, the shutter mode of the image sensor 2200 may be changed.

In some embodiments, the image sensor 2200 may operate in the target shutter mode during a frame period which starts after a time point at which the sensor controller 2100 determines to change the shutter mode of the image sensor 2200.

FIG. 13 is a diagram describing an operating method of a system-on-chip of FIG. 12, according to some embodiments. Referring to FIG. 13, the system-on-chip may include the sensor controller 2100 and the image sensor 2200.

In operation S410, the image sensor 2200 may generate first image data in the first shutter mode SM1.

In operation S420, the image sensor 2200 may provide the first image data to the sensor controller 2100.

In operation S430, the sensor controller 2100 may determine to change the shutter mode of the image sensor 2200 to the second shutter mode SM2 based on photographing environment information associated with the first image data.

In operation S440, the sensor controller 2100 may change a setting of the image sensor 2200 so as to operate in the second shutter mode SM2.

In some embodiments, operation S440 may include determining, by a sensor controller, the second shutter mode as the target shutter mode based on the photographing environment information associated with the first image data, obtaining, by the sensor controller, first setting data corresponding to the second shutter mode, and changing, by the sensor controller, a setting of an image sensor based on the first setting data.

In some embodiments, the changing of the setting of the image sensor based on the first setting data by the sensor controller may include providing, by the sensor controller, at least one setting value of the first setting data to the image sensor, and storing, by the image sensor, the at least one setting value in at least one register.

In the system-on-chip 2000 according to embodiments, the sensor controller 2100 may analyze photographing environment information and may determine whether to change the shutter mode of the image sensor 2200.

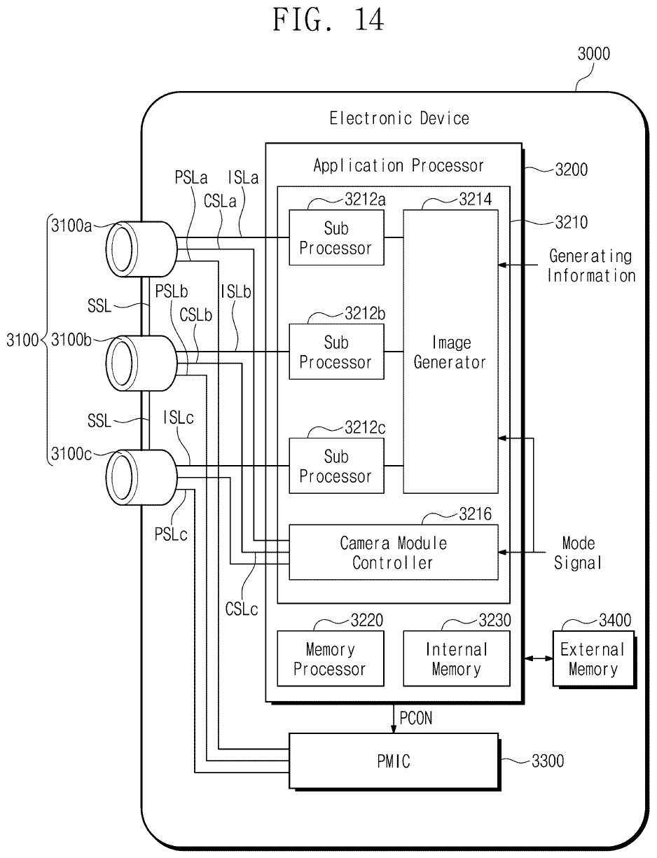

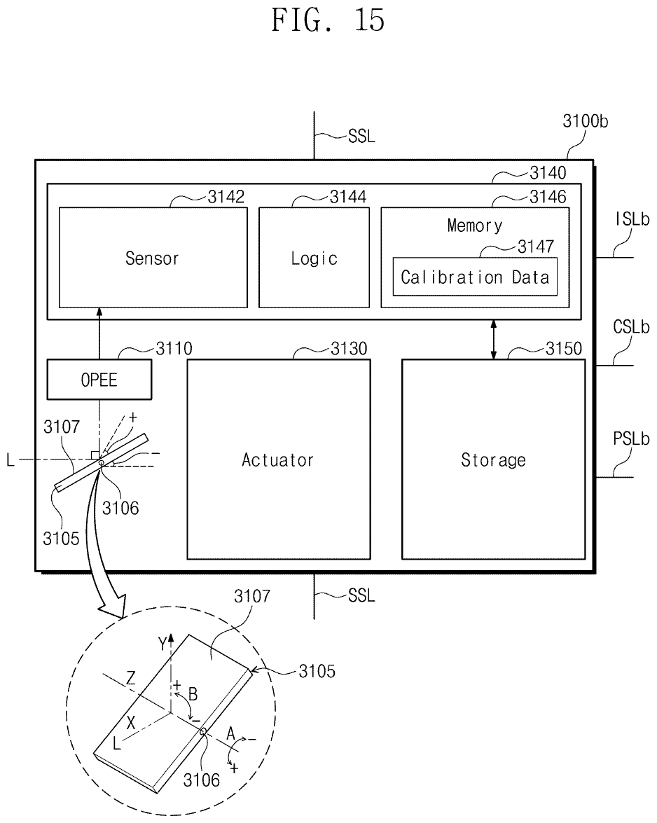

FIG. 14 is a block diagram of an electronic device including a multi-camera module. FIG. 15 is a block diagram illustrating a camera module of FIG. 14 in detail.

Referring to FIG. 14, an electronic device 3000 may include a camera module group 3100, an application processor 3200, a PMIC 3300, and an external memory 3400. The camera module group 3100 may include the image sensor 1220 of FIG. 2. The application processor 3200 may correspond to the application processor 1100 of FIG. 1.

The camera module group 3100 may include a plurality of camera modules 3100a, 3100b, and 3100c. An electronic device including three camera modules 3100a, 3100b, and 3100c is illustrated in FIG. 14, but embodiments are not limited thereto. In some embodiments, the camera module group 3100 may be modified to include only two camera modules. Also, in some embodiments, the camera module group 3100 may be modified to include “n” camera modules (n being a natural number of 4 or more).

Below, a detailed configuration of the camera module 3100b will be more fully described with reference to FIG. 15, but the following description may be equally applied to the remaining camera modules 3100a and 3100c.

Referring to FIG. 15, the camera module 3100b may include a prism 3105, an optical path folding element (OPFE) 3110, an actuator 3130, an image sensing device 3140, and storage 3150.

The prism 3105 may include a reflecting plane 3107 of a light reflecting material and may change a path of a light “L” incident from the outside.

In some embodiments, the prism 3105 may change a path of the light “L” incident in a first direction (X) to a second direction (Y) perpendicular to the first direction (X), Also, the prism 3105 may change the path of the light “L” incident in the first direction (X) to the second direction (Y) perpendicular to the first (X-axis) direction by rotating the reflecting plane 3107 of the light reflecting material in direction “A” about a central axis 3106 or rotating the central axis 3106 in direction “B”. In this case, the OPFE 3110 may move in a third direction (Z) perpendicular to the first direction (X) and the second direction (Y).

In some embodiments, as illustrated in FIG. 15, a maximum rotation angle of the prism 3105 in direction “A” may be equal to or less than 15 degrees in a positive A direction and may be greater than 15 degrees in a negative A direction, but embodiments are not limited thereto.

In some embodiments, the prism 3105 may move within approximately 20 degrees in a positive or negative B direction, between 10 degrees and 20 degrees, or between 15 degrees and 20 degrees; here, the prism 3105 may move at the same angle in the positive or negative B direction or may move at a similar angle within approximately 1 degree.

In some embodiments, the prism 3105 may move the reflecting plane 3107 of the light reflecting material in the third direction (e.g., Z direction) parallel to a direction in which the central axis 3106 extends.

The OPFE 3110 may include optical lenses composed of “m” groups (m being a natural number), for example. Here, “m” lens may move in the second direction (Y) to change an optical zoom ratio of the camera module 3100b. For example, when a default optical zoom ratio of the camera module 3100b is “Z”, the optical zoom ratio of the camera module 3100b may be changed to an optical zoom ratio of 3Z, 5Z, or 5Z or more by moving “m” optical lens included in the OPFE 3110.

The actuator 3130 may move the OPFE 3110 or an optical lens (hereinafter referred to as an “optical lens”) to a specific location. For example, the actuator 3130 may adjust a location of an optical lens such that an image sensor 3142 is placed at a focal length of the optical lens for accurate sensing.

The image sensing device 3140 may include the image sensor 3142, control logic 3144, and a memory 3146. The image sensor 3142 may sense an image of a sensing target by using the light “L” provided through an optical lens. The control logic 3144 may control overall operations of the camera module 3100b. For example, the control logic 3144 may control an operation of the camera module 3100b based on a control signal provided through a control signal line CSLb.

The memory 3146 may store information, which is necessary for an operation of the camera module 3100b, such as calibration data 3147. The calibration data 3147 may include information necessary for the camera module 3100b to generate image data by using the light “L” provided from the outside. The calibration data 3147 may include, for example, information about the degree of rotation described above, information about a focal length, information about an optical axis, etc. In the case where the camera module 3100b is implemented in the form of a multi-state camera in which a focal length varies depending on a location of an optical lens, the calibration data 3147 may include a focal length value for each location (or state) of the optical lens and information about auto focusing.

The storage 3150 may store image data sensed through the image sensor 3142. The storage 3150 may be disposed outside the image sensing device 3140 and may be implemented in a shape where the storage 3150 and a sensor chip constituting the image sensing device 3140 are stacked. In some embodiments, the storage 3150 may be implemented with an electrically erasable programmable read only memory (EEPROM), but embodiments are not limited thereto.

Referring together to FIGS. 14 and 15, in some embodiments, each of the plurality of camera modules 3100a, 3100b, and 3100c may include the actuator 3130. As such, the same calibration data 3147 or different calibration data 3147 may be included in the plurality of camera modules 3100a, 3100b, and 3100c depending on operations of the actuators 3130 therein.

In some embodiments, one camera module (e.g., 3100b) among the plurality of camera modules 3100a, 3100b, and 3100c may be a folded lens shape of camera module in which the prism 3105 and the OPFE 3110 described above are included, and the remaining camera modules (e.g., 3100a and 3100c) may be a vertical shape of camera module in which the prism 3105 and the OPFE 3110 described above are not included; however, embodiments are not limited thereto.

In some embodiments, one camera module (e.g., 3100c) among the plurality of camera modules 3100a, 3100b, and 3100c may be, for example, a vertical shape of depth camera extracting depth information by using an infrared ray (IR). In this case, the application processor 3200 may merge image data provided from the depth camera and image data provided from any other camera module (e.g., 3100a or 3100b) and may generate a three-dimensional (3D) depth image.

In some embodiments, at least two camera modules (e.g., 3100a and 3100b) among the plurality of camera modules 3100a, 3100b, and 3100c may have different fields of view. In this case, the at least two camera modules (e.g., 3100a and 3100b) among the plurality of camera modules 3100a, 3100b, and 3100c may include different optical lens, but embodiments are not limited thereto.

Also, in some embodiments, fields of view of the plurality of camera modules 3100a, 3100b, and 3100c may be different. In this case, the plurality of camera modules 3100a, 3100b, and 3100c may include different optical lens, not limited thereto.

In some embodiments, the plurality of camera modules 3100a, 3100b, and 3100c may be disposed to be physically separated from each other. That is, the plurality of camera modules 3100a, 3100b, and 3100c may not use a sensing area of one image sensor 3142, but the plurality of camera modules 3100a, 3100b, and 3100c may include independent image sensors 3142 therein, respectively.

Returning to FIG. 14, the application processor 3200 may include an image processing device 3210, a memory controller 3220, and an internal memory 3230. The application processor 3200 may be implemented to be separated from the plurality of camera modules 3100a, 3100b, and 3100c. For example, the application processor 3200 and the plurality of camera modules 3100a, 3100b, and 3100c may be implemented with separate semiconductor chips.

The image processing device 3210 may include a plurality of sub image processors 3212a, 3212b, and 3212c, an image generator 3214, and a camera module controller 3216.

The image processing device 3210 may include the plurality of sub image processors 3212a, 3212b, and 3212c, the number of which corresponds to the number of the plurality of camera modules 3100a, 3100b, and 3100c.

Image data respectively generated from the camera modules 3100a, 3100b, and 3100c may be respectively provided to the corresponding sub image processors 3212a, 3212b, and 3212c through separated image signal lines ISLa, ISLb, and ISLc. For example, the image data generated from the camera module 3100a may be provided to the sub image processor 3212a through the image signal line ISLa, the image data generated from the camera module 3100b may be provided to the sub image processor 3212b through the image signal line ISLb, and the image data generated from the camera module 3100c may be provided to the sub image processor 3212c through the image signal line ISLc. This image data transmission may be performed, for example, by using a camera serial interface (CSI) based on the MIPI (Mobile Industry Processor Interface), but embodiments are not limited thereto.

In some embodiments, one sub image processor may be disposed to correspond to a plurality of camera modules. For example, the sub image processor 3212a and the sub image processor 3212c may be integrally implemented, not separated from each other as illustrated in FIG. 16; in this case, one of the pieces of image data respectively provided from the camera module 3100a and the camera module 3100c may be selected through a selection element (e.g., a multiplexer), and the selected image data may be provided to the integrated sub image processor.

The image data respectively provided to the sub image processors 3212a, 3212b, and 3212c may be provided to the image generator 3214. The image generator 3214 may generate an output image by using the image data respectively provided from the sub image processors 3212a, 3212b, and 3212c, depending on image generating information Generating Information or a mode signal.

In detail, the image generator 3214 may generate the output image by merging at least a portion of the image data respectively generated from the camera modules 3100a, 3100b, and 3100c having different fields of view, depending on the image generating information Generating Information or the mode signal. Also, the image generator 3214 may generate the output image by selecting one of the image data respectively generated from the camera modules 3100a, 3100b, and 3100c having different fields of view, depending on the image generating information Generating Information or the mode signal.

In some embodiments, the image generating information Generating Information may include (i.e., indicate) a zoom signal or a zoom factor. Also, in some embodiments, the mode signal may be, for example, a signal based on a mode selected from a user.

In the case where the image generating information Generating Information is the zoom signal (or zoom factor) and the camera modules 3100a, 3100b, and 3100c have different visual fields of view, the image generator 3214 may perform different operations depending on a kind of the zoom signal. For example, in the case where the zoom signal is a first signal, the image generator 3214 may merge the image data output from the camera module 3100a and the image data output from the camera module 3100c and may generate the output image by using the merged image signal and the image data output from the camera module 3100b that is not used in the merging operation. In the case where the zoom signal is a second signal different from the first signal, without the image data merging operation, the image generator 3214 may select one of the image data respectively output from the camera modules 3100a, 3100b, and 3100c and may output the selected image data as the output image. However, embodiments are not limited thereto, and a way to process image data may be modified as necessary.

In some embodiments, the image generator 3214 may generate merged image data having an increased dynamic range by receiving a plurality of image data of different exposure times from at least one of the plurality of sub image processors 3212a, 3212b, and 3212c and performing high dynamic range (HDR) processing on the plurality of image data.

The camera module controller 3216 may provide control signals to the camera modules 3100a, 3100b, and 3100c, respectively. The control signals generated from the camera module controller 3216 may be respectively provided to the corresponding camera modules 3100a, 3100b, and 3100c through control signal lines CSLa, CSLb, and CSLc separated from each other.

One of the plurality of camera modules 3100a, 3100b, and 3100c may be designated as a master camera (e.g., 3100b) depending on the image generating information Generating Information including a zoom signal or the mode signal, and the remaining camera modules (e.g., 3100a and 3100c) may be designated as a slave camera. The above designation information may be included in the control signals, and the control signals including the designation information may be respectively provided to the corresponding camera modules 3100a, 3100b, and 3100c through the control signal lines CSLa, CSLb, and CSLc separated from each other.

Camera modules operating as a master and a slave may be changed depending on the zoom factor or an operating mode signal. For example, in the case where the field of view of the camera module 3100a is wider than the field of view of the camera module 3100b and the zoom factor indicates a low zoom ratio, the camera module 3100b may operate as a master, and the camera module 3100a may operate as a slave. In contrast, in the case where the zoom factor indicates a high zoom ratio, the camera module 3100a may operate as a master, and the camera module 3100b may operate as a slave.

In some embodiments, the control signal provided from the camera module controller 3216 to each of the camera modules 3100a, 3100b, and 3100c may include a sync enable signal. For example, in the case where the camera module 3100b is used as a master camera and the camera modules 3100a and 3100c are used as a slave camera, the camera module controller 3216 may transmit the sync enable signal to the camera module 3100b. The camera module 3100b that is provided with sync enable signal may generate a sync signal based on the provided sync enable signal and may provide the generated sync signal to the camera modules 3100a and 3100c through a sync signal line SSL. The camera module 3100b and the camera modules 3100a and 3100c may be synchronized with the sync signal to transmit image data to the application processor 3200.

In some embodiments, the control signal provided from the camera module controller 3216 to each of the camera modules 3100a, 3100b, and 3100c may include mode information according to the mode signal. Based on the mode information, the plurality of camera modules 3100a, 3100b, and 3100c may operate in a first operating mode and a second operating mode with regard to a sensing speed.

In the first operating mode, the plurality of camera modules 3100a, 3100b, and 3100c may generate image signals at a first speed (e.g., may generate image signals of a first frame rate), may encode the image signals at a second speed (e.g., may encode the image signal of a second frame rate higher than the first frame rate), and transmit the encoded image signals to the application processor 3200. In this case, the second speed may be 30 times or less the first speed.

The application processor 3200 may store the received image signals, that is, the encoded image signals in the memory 3230 provided therein or the external memory 3400 placed outside the application processor 3200. Afterwards, the application processor 3200 may read and decode the encoded image signals from the memory 3230 or the external memory 3400, and may display image data generated based on the decoded image signals. For example, the corresponding one among sub image processors 3212a, 3212b, and 3212c of the image processing device 3210 may perform decoding and may also perform image processing on the decoded image signal.

In the second operating mode, the plurality of camera modules 3100a, 3100b, and 3100c may generate image signals at a third speed (e.g., may generate image signals of a third frame rate lower than the first frame rate) and transmit the image signals to the application processor 3200. The image signals provided to the application processor 3200 may be signals that are not encoded. The application processor 3200 may perform image processing on the received image signals or may store the image signals in the memory 3230 or the external memory 3400.

The PMIC 3300 may supply powers, for example, power supply voltages to the plurality of camera modules 3100a, 3100b, and 3100c, respectively. For example, under control of the application processor 3200, the PMIC 3300 may supply a first power to the camera module 3100a through a power signal line PSLa, may supply a second power to the camera module 3100b through a power signal line PSLb, and may supply a third power to the camera module 3100c through a power signal line PSLc.

In response to a power control signal PCON from the application processor 3200, the PMIC 3300 may generate a power corresponding to each of the plurality of camera modules 3100a, 3100b, and 3100c and may adjust a level of the power. The power control signal PCON may include a power adjustment signal for each operating mode of the plurality of camera modules 3100a, 3100b, and 3100c. For example, the operating mode may include a low-power mode. In this case, the power control signal PCON may include information about a camera module operating in the low-power mode and a set power level. Levels of the powers respectively provided to the plurality of camera modules 3100a, 3100b, and 3100c may be identical to each other or may be different from each other. Also, a level of a power may be dynamically changed.

According to an embodiment, an image sensing device switching a shutter mode depending on a photographing environment, an electronic device including the image sensing device, and an operating method of the electronic device are provided.

Also, an image sensing device which is capable of performing fast switching between shutter modes as an application processor or a sensor controller determines whether to change a shutter mode in real time based on photographing environment information and changes the shutter mode, that is, provides improved performance and an electronic device including the same are provided.

While aspects of embodiments have been particularly shown and described, it will be understood that various changes in form and details may be made therein without departing from the spirit and scope of the following claims.

What is claimed is:

1. A method of operating an electronic device which includes an application processor and an image sensing device, the method comprising:
generating, by the image sensing device, first image data in a first shutter mode;
providing, by the application processor, the image sensing device with a first mode change signal indicating a second shutter mode different from the first shutter mode, based on photographing environment information associated with the first image data, to the image sensing device; and
generating, by the image sensing device, second image data in the second shutter mode, based on the first mode change signal.

2. The method of claim 1, wherein the first shutter mode is one of a rolling shutter mode and a global shutter mode, and the second shutter mode is another of the rolling shutter mode and the global shutter mode.

3. The method of claim 1, wherein the image sensing device is a system-on-chip.

4. The method of claim 1, wherein the generating of the second image data in the second shutter mode based on the first mode change signal comprises:
obtaining, by the image sensing device, first setting data corresponding to the second shutter mode, based on the first mode change signal;
changing, by the image sensing device, a setting of an image sensor of the image sensing device, based on the first setting data; and
generating, by the image sensor, the second image data based on the changed setting.

5. The method of claim 4, wherein the first setting data are stored in a sensor controller of the image sensing device or the image sensor.

6. The method of claim 1, wherein the image sensing device operates in the second shutter mode during a frame period which starts after a time point at which the first mode change signal is received from the application processor.

7. The method of claim 1, further comprising obtaining, by the application processor, the photographing environment information from at least one of the first image data, metadata of the first image data provided from the image sensing device together with the first image data, and metadata of the first image data stored in the application processor.

8. The method of claim 1, wherein the photographing environment information includes any one or any combination of illuminance information, gain amplification information, and movement information.

9. The method of claim 8, wherein the first shutter mode is a global shutter mode and the second shutter mode is a rolling shutter mode, and
wherein the providing of the image sensing device with the first mode change signal indicating the second shutter mode comprises:
determining, by the application processor, that an illuminance value indicated by the illuminance information is less than a first threshold value;
generating, by the application processor, the first mode change signal indicating the second shutter mode based on the illuminance value being less than the first threshold value; and
providing, by the application processor, the first mode change signal to the image sensing device.

10. The method of claim 8, wherein the first shutter mode is a rolling shutter mode and the second shutter mode is a global shutter mode, and
wherein the providing of the image sensing device with the first mode change signal indicating the second shutter mode comprises:
determining, by the application processor, that an illuminance value indicated by the illuminance information is greater than a second threshold value;
generating, by the application processor, the first mode change signal indicating the second shutter mode based on the illuminance value being greater than the second threshold value; and
providing, by the application processor, the first mode change signal to the image sensing device.

11. The method of claim 8, wherein the first shutter mode is a rolling shutter mode and the second shutter mode is a global shutter mode, and
wherein the providing of the image sensing device with the first mode change signal indicating the second shutter mode comprises:
determining, by the application processor, that a movement amount indicated by the movement information is greater than a third threshold value;
generating, by the application processor, the first mode change signal indicating the second shutter mode based on the movement amount being greater than the third threshold value; and
providing, by the application processor, the first mode change signal to the image sensing device.

12. The method of claim 8, wherein the first shutter mode is a global shutter mode and the second shutter mode is a rolling shutter mode, and
wherein the providing of the image sensing device with the first mode change signal indicating the second shutter mode comprises:
determining, by the application processor, that a movement amount of the movement information is less than a fourth threshold value;
generating, by the application processor, the first mode change signal indicating the second shutter mode based on the movement amount being less than the fourth threshold value; and
providing, by the application processor, the first mode change signal to the image sensing device.

13. The method of claim 8, wherein the first shutter mode is a rolling shutter mode and the second shutter mode is a global shutter mode, and
wherein the providing of the image sensing device with the first mode change signal indicating the second shutter mode comprises:
determining, by the application processor, that a multiple value indicated by the gain amplification information is less than a fifth threshold value;
generating, by the application processor, the first mode change signal indicating the second shutter mode based on the multiple value being less than the fifth threshold value; and
providing, by the application processor, the first mode change signal to the image sensing device.

14. The method of claim 8, wherein the first shutter mode is a global shutter mode and the second shutter mode is a rolling shutter mode, and
wherein the providing of the image sensing device with the first mode change signal indicating the second shutter mode comprises:
determining, by the application processor, that a multiple value indicated by the gain amplification information is greater than a sixth threshold value;
generating, by the application processor, the first mode change signal indicating the second shutter mode based on the multiple value being greater than the sixth threshold value; and
providing, by the application processor, the first mode change signal to the image sensing device.

15. A method of operating a system-on-chip which includes a sensor controller and an image sensor, the method comprising:
generating, by the image sensor, first image data in a first shutter mode;
changing, by the sensor controller, a setting of the image sensor based on photographing environment information associated with the first image data to control the image sensor to operate in a second shutter mode different from the first shutter mode; and
generating, by the image sensor, second image data in the second shutter mode.

16. The method of claim 15, wherein the changing of the setting of the image sensor comprises:
determining, by the sensor controller, the second shutter mode as a target shutter mode, based on the photographing environment information associated with the first image data;
obtaining, by the sensor controller, first setting data corresponding to the second shutter mode; and
changing, by the sensor controller, the setting of the image sensor based on the first setting data.

17. The method of claim 16, wherein the changing of the setting of the image sensor based on the first setting data comprises:
providing, by the sensor controller, at least one setting value of the first setting data to the image sensor; and
storing, by the image sensor, the at least one setting value in at least one register of the image sensor.

18. The method of claim 16, wherein the image sensor operates in the second shutter mode during a frame period which starts after a time point at which the sensor controller determines the second shutter mode as the target shutter mode.

19. The method of claim 15, further comprising obtaining the photographing environment information from any one or any combination of the first image data, metadata of the first image data provided from the image sensor together with the first image data, and metadata of the first image data stored in an application processor communicating with the system-on-chip.

20. An electronic device comprising:
an image sensing device configured to generate first image data in a first shutter mode and a second shutter mode; and
an application processor configured to provide the image sensing device with a first mode change signal indicating a shutter mode different from a current shutter mode, based on photographing environment information associated with the first image data.
